(19) United States
(12) Patent Application Publication
(10) Pub. No.: US 2004/0148207 A1
(43) Pub. Date: Jul. 29, 2004

(54) Method and system for facilitating the making of travel arrangement for a travel group using web-enabled tools

(75) Inventors: Adam M. Smith, Cambridge, MA (US); David T. Knapp, Cornellus, NC (US)

Correspondence Address: HARRINGTON & SMITH, LLP, 4 RESEARCH DRIVE, SHELTON, CT, 06484-6212, US

(73) Assignee: Traveling Party Inc.

(21) Appl. No.: 10/759,331

(22) Filed: Jan. 15, 2004

Related U.S. Application Data
(60) Provisional application No. 60/440,563, filed on Jan. 16, 2003.

(51) Int. Cl. G06F 17/60

(52) U.S. Cl. 705/6; 705/5

(57) ABSTRACT

A method to plan a trip comprises, at a travel service site, establishing a homepage for the trip; contacting, such as by emailing, potential trip participants from the travel service site for informing them of the existence of the trip homepage; and making travel arrangements related to the trip by using tools provided to the potential trip participants at the trip homepage. The travel arrangements may include arranging payment for the trip, and/or arranging accommodations during the trip. The travel arrangements may also include determining which trip participants will share lodging accommodations during the trip.

### CLAIM OF PRIORITY FROM COPENDING PROVISIONAL PATENT APPLICATION

This patent application claims priority under 35 U.S.C. §119(e) from Provisional Patent Application No. 60/440,563, filed Jan. 16, 2003, the disclosure of which is incorporated by reference herein in its entirety.

### TECHNICAL FIELD

This invention relates generally to travel-related scheduling and booking systems and, more specifically, this invention pertains to network-based commerce, such as Internet-based commercial web sites for booking and scheduling travel for a plurality of trip participants, also referred to herein as a travel group.

### BACKGROUND

The use of Internet sites and services to make travel arrangements, including airline and hotel reservations, are well known and widely used. However, currently available Internet sites and services are directed primarily to individual travelers and tightly knit, localized and homogeneous travel groups, such as families. The currently available Internet sites and services thus do not adequately address the needs of more loosely knit and heterogenous travel groups that may be distributed over a wide geographical area.

The currently available Internet sites and services also do not adequately address the needs of travel group participants that may travel at different times, by different routes, and that may have different accommodations.

A need thus exists to provide a travel service that addresses the concerns of loosely knit, spatially distributed and heterogenous travel groups. Prior to this invention, this need has not been adequately addressed or fulfilled.

Representative U.S. Patents that relate both to travel and the Internet include U.S. Pat. No. 6,304,850 B1, Keller et all., “Computer-Implemented System and Method for Booking Airline Travel Itineraries” (Netmarket Group, Inc.); U.S. Pat. No. 6,256,639 B1, Himmel et al., “Providing Internet Travel Services via Bookmark Set” (IBM Corp); and U.S. Pat. No. 5,948,040, DeLorme et al., “Travel Reservation Information and Planning System” (DeLorme Publishing Co.). The systems and methods disclosed by these patents do not overcome the problems referred to above.

It is known in the art to provide an Internet site that functions as an online invitation service for use in scheduling events, such as dinnerparties and the like (www.evite.com). The Evite™ site enables a person (a host) to identify a type of event, and to enter email addresses of invitees (guests). An email is sent to each of the email addressees informing the addressee of the invitation, and includes a link to a host page dedicated to the event. A host version of the page includes several host editing tools (e.g., edit event notes, edit event details, customize, edit guest responses, change privacy options, change an organizer, export the guest list, save the guest list as an Evite™ group, copy the event and cancel the event). The guest version of the page is more limited in its functionality, and provides an ability to indicate whether the guest will attend and to add a text comment. The guest's reply can be posted. Information as to other guests is also made available, as is an ability to send a message to everyone, see the answers of other guests, and to be removed from the guest list.

The Evite™ site does not address, and does not thus overcome, the problems referred to above with respect to group travel.

### SUMMARY OF THE PREFERRED EMBODIMENTS

The foregoing and other problems are overcome, and other advantages are realized, in accordance with the presently preferred embodiments of this invention.

Disclosed herein is a method and a system for selling travel services and organizing group-travel logistics over a network, preferably a global communications network such as the Internet. The service assumes the existence of, for a given travel expedition or trip, a trip leader. The trip leader initiates the planning, organization and arrangement of a trip. The method and system provides the trip leader with a dynamically generated personalized webpage that makes available a plurality of tools to enable trip participants, i.e., the members of the travel or trip group, to access trip-related information, communicate via a message board, vote on trip-related matters, arrange room assignments, track flight and seating information, show participation and payment status, make travel reservations and make arrangements to pay for the trip. The trip leader invites people via a web-based tool. Each trip thus has an associated webpage through which the trip participants, including the trip leader, interact so as to plan, organize and finalize the trip.

In the presently preferred embodiment each trip participant and user of the network-enabled service receives an account that remains open and in effect after the end of the trip so that the users can initiate and plan other trips.

A method to plan a trip includes, at a travel service site, establishing a homepage for the trip; contacting (such as by email) potential trip participants from the travel service site for informing them of the existence of the trip homepage; and making travel arrangements related to the trip by using tools provided to the potential trip participants at the trip homepage. The travel arrangements may include arranging payment for the trip, and/or arranging accommodations during the trip. The travel arrangements may also include determining which trip participants will share lodging accommodations during the trip.

Also disclosed is a system operable to provide a group travel service over the Internet. The system includes a server executing software for implementing the group travel service. The server is bidirectionally coupled to the Internet and is responsive to a group trip leader identifying at least contact information, such as email addresses, of potential group trip participants for automatically contacting the potential group trip participants for providing them with a link to a group trip homepage. The server is further responsive to potential group trip participants accessing the group trip homepage for making travel arrangements related to the group trip by using tools provided to the potential trip participants at the group trip homepage. The travel arrangements may include at least one of arranging payment for the trip and arranging accommodations during the trip. The travel arrangements may further include determining which trip participants will share lodging accommodations during the trip. In a preferred embodiment one of the tools enables trip participants to vote on matters related to the trip.

It is also within the scope of this invention for the server to establish a travel service homepage for enabling a member of the public to learn of the existence of the group trip, and to join the group trip as a group trip participant using at least the group trip homepage.

It is also within the scope of this invention for the server to establish a travel log album for the trip at the travel service site, and to provide both group trip participants and members of the public access to the travel log album. In this case at least group trip participants are enabled to upload photographs to the travel log album, and group trip participants and members of the public are enabled to download photographs from the travel log album.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram of a travel service system in accordance with the invention;

FIGS. 2 and 3 are examples of two exemplary screens that can be presented to a user of the travel service system of FIG. 1; and

FIGS. 4, 5, 6 and 7 are further examples of exemplary screens that can be presented to a user of the travel service system of FIG. 1.

### DETAILED DESCRIPTION OF THE PREFERRED EMBODIMENTS

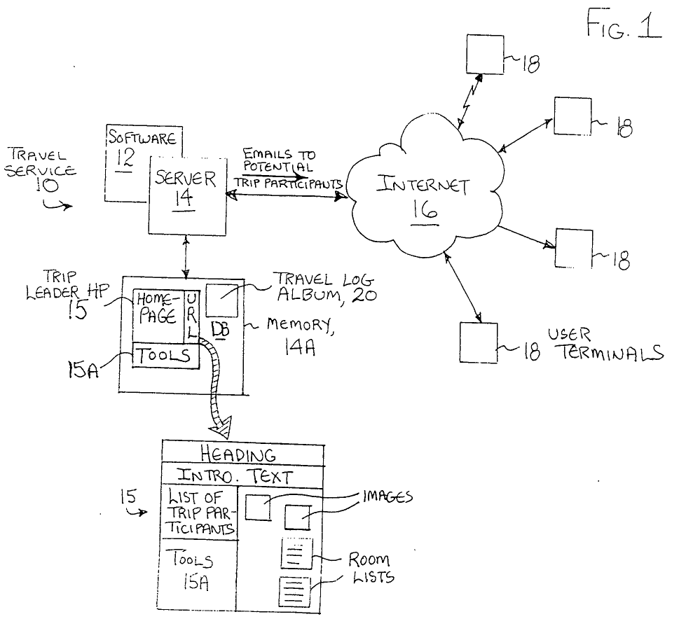

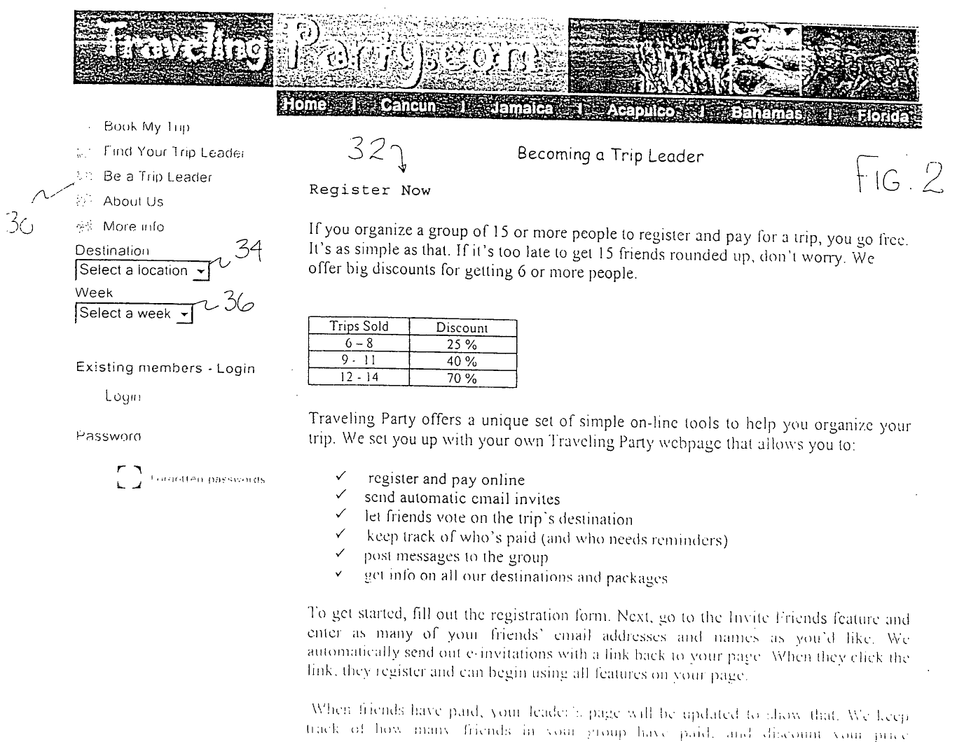

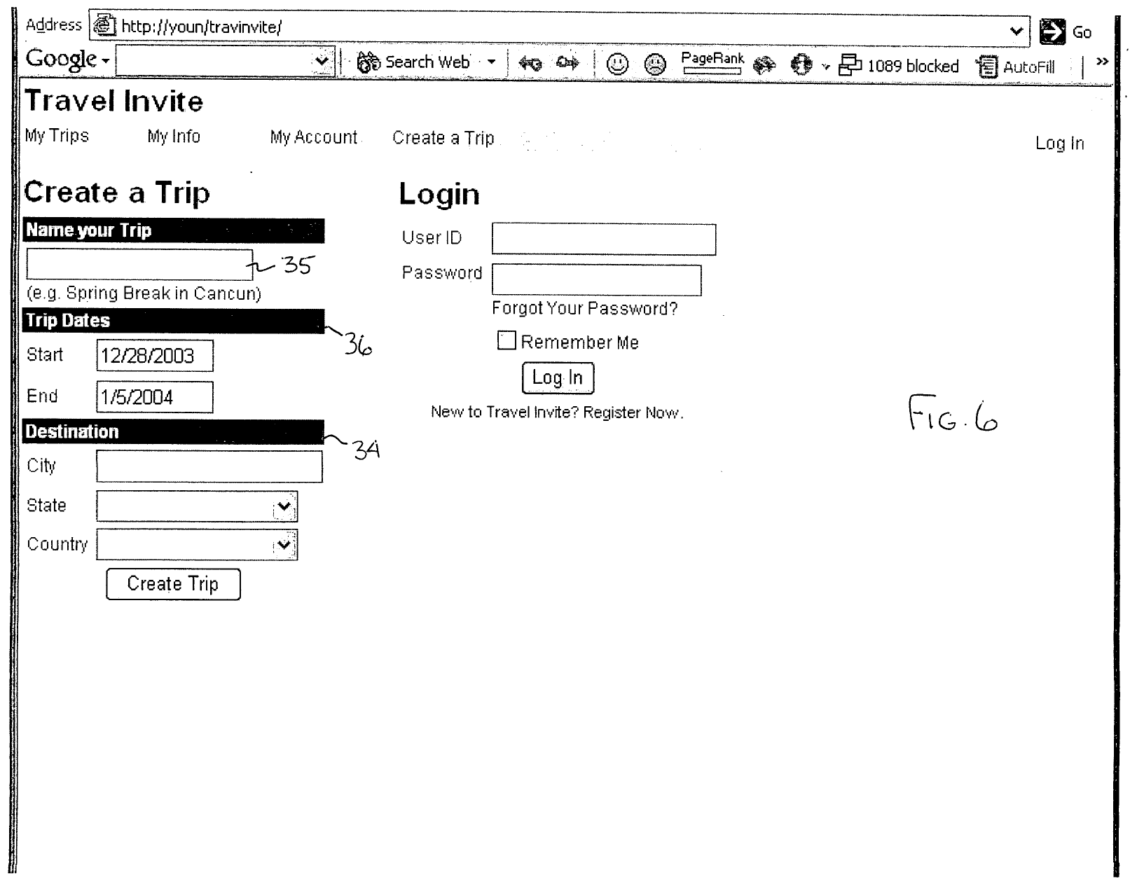

The system and method of this invention are referred to herein for convenience, and not be way of limitation, as a travel service. Referring to FIG. 1, the travel service 10 may be embodied as software 12 running on at least one computer, also referred to herein as a server 14, that is bidirectionally coupled to a global data communications network 16, such as the Internet. Users gain access to the travel service 10 over the network 16 from local terminals 18, which can be PCs, workstations, wireless Internet connectivity devices such as cellular telephones and personal organizers, or by any suitable technique. One of the users is assumed to be a group trip leader (also referred to as a group leader), and at least one other user is assumed to be a group trip participant. Note that the trip leader's role may not be to actually “lead” a group tripper se, although in some cases the travel service 10 “Trip Leader” is actually the trip leader as well (e.g., a professional kayaker who is taking a small group of novice kayakers on a kayaking trip). For the purposes of this invention the trip leader is assumed to be an individual who first contacts the travel service 10 to initiate the planning of a particular group trip, whether or not this individual actually leads the trip itself. By so contacting the travel service 10 this user is granted the status of the trip leader upon the user's request (see FIG. 2, item 30). By clicking or checking this box, the user is presented with a screen, such as one similar to the one shown in FIG. 2 as 32, or the embodiment illustrated in FIG. 6. Note that in some circumstances an incentive to assume the role of trip leader may be an ability to obtain a discount on that particular user's travel expenses. However, the travel service 10 may also be used by a group when planning a trip, such as a hike along the Appalachian trail, where there is little or no cost involved, and little or no need for professional travel arrangements.

Note as well that this screen enables the trip leader to possibly select a destination 34 and a time 36 (e.g., a week) for the group trip. While shown as being implemented as drop down menus, any suitable user interface technique could be used for implementing these functions, such as displaying a map to the user and enabling the user to click on a map location, and/or displaying a calendar to the user and enabling the user to select a range of dates. In another embodiment the trip participants vote on a trip destination and/or dates, using tools provided on the trip leader's webpage or homepage 15, as described in further detail below.

When registering as a trip leader the user enters at least the names and electronic notification contact information, such as electronic mail (email) addresses of possible trip participants. The trip leader may also enter other information, such as a proposed trip location, proposed trip dates and so forth. After registration, a trip leader homepage 15 is dynamically created by the travel service 10 and stored in a memory 14A of the server 14. The homepage 15 is assigned a URL for enabling subsequent access directly to the homepage 15 by the trip leader, trip participants and possibly other interested parties, as described below. Subsequent to the establishment of the trip leader's homepage 15, the travel service 10 automatically electronically notifies, such as by email, each of the identified trip participants to inform them that the trip leader has established the homepage 15 with the travel service 10. The email message sent to each proposed trip participant includes a link to the homepage 15 to facilitate the proposed trip participant reaching the homepage 15.

As employed herein, “electronic notification” can comprise a message sent by electronic mail (email), or a cellular telephone or other type of text message, or an instant message, or any technique for reaching a person. As a further example, one or more potential trip participants may be automatically telephoned with a pre-recorded message left by the group leader, or the message concerning the trip may be delivered to the potential trip participant through a voice synthesis means, based on the parameters (e.g., trip destination and dates) established by the trip leader upon registration. The message preferably includes a link or an identification of the link (URL) to the group trip homepage.

The homepage 15 provides a set of tools 15A that enables the trip participants to interact with one another, with the trip leader, with the trip service 10, and possibly with third party suppliers of trip-related goods and services, for scheduling the trip, establishing and modifying the trip itinerary and paying for the trip.

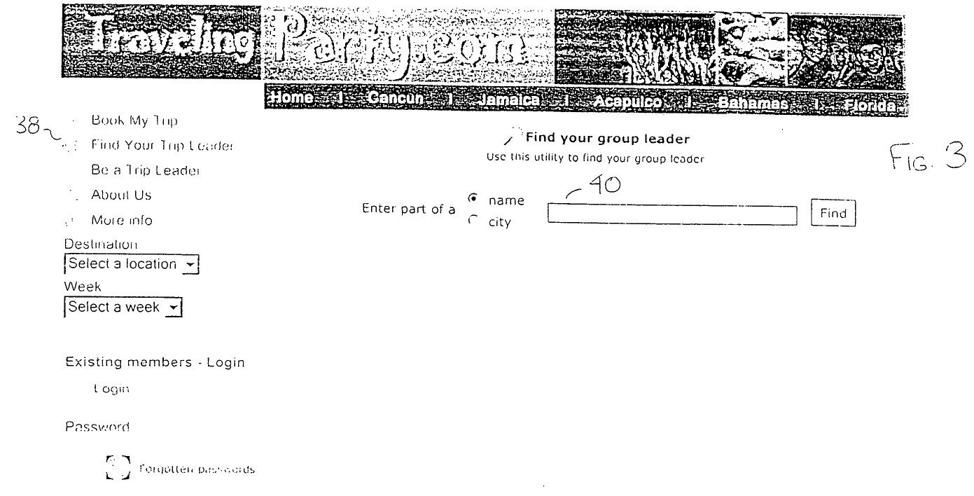

FIG. 3 shows an optional screen, entered by checking block 38, that enables a trip participant or other interested party to locate the homepage 15 of the trip leader using tool 40, in the event the trip participant does not have the URL of the trip leader's homepage 15.

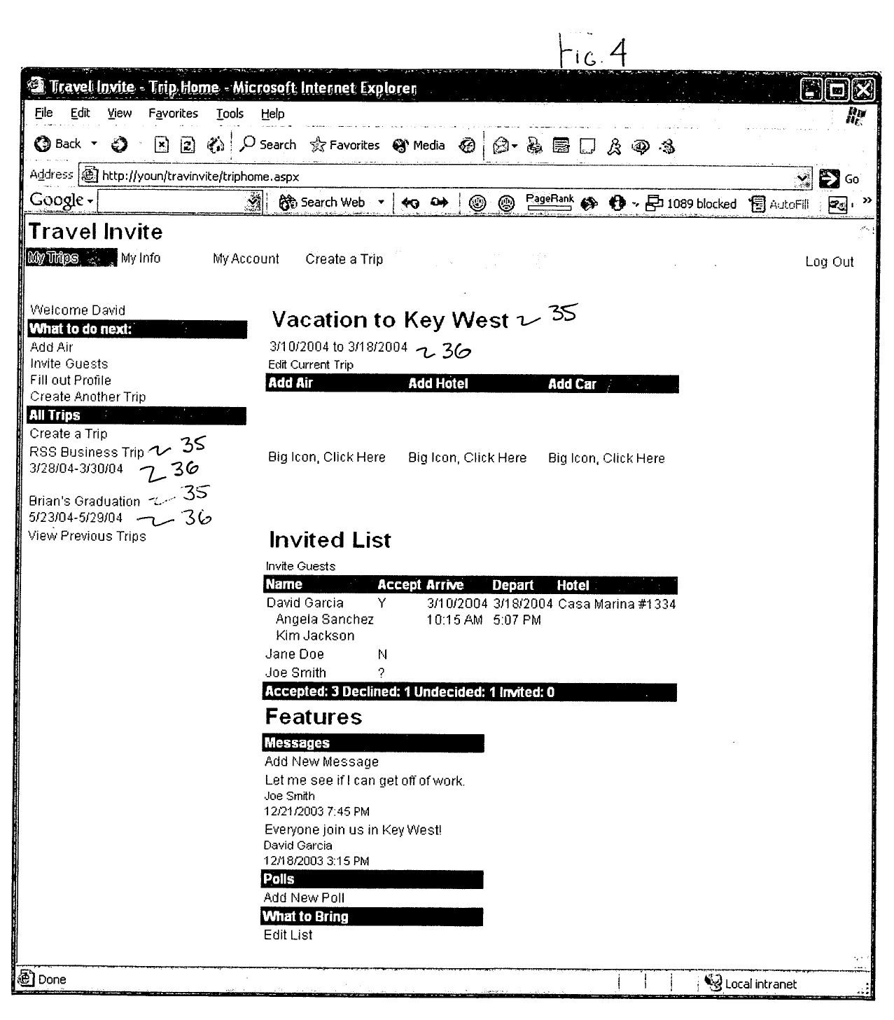

In greater detail, the trip leader registers with the travel service 10 and is assigned the personal webpage or homepage 15 and a homepage for that trip. The trip leader then either selects a destination and dates of travel (such as by using blocks 34, 36), or enables the identified trip participants to vote on the destination and/or dates, and possibly on hotels and added trip events. The trip leader may choose the trip's destination and dates of travel at any time. The trip leader is preferably able to customize certain fields of the homepage 15 (see block 35 of FIG. 6), such as a heading, e.g., “Trip XYZ” becomes “Our Fantastic Voyage Down Under”, or “Class of 1963 40^{th} Reunion”, or “Sally and Bill's Wedding”; and/or introductory text; and/or optional images, such as photos, to be included on the homepage 15. Note that the images may be selected from a stock gallery of images provided by the travel service 10 (or by some third party provider as a value added feature) that are placed on the homepage in a preprogrammed format, or in a format selected by the trip leader. Other functions of the homepage customization may include, but are not limited to, selecting color schemes, uploading logos, choosing from preset layouts or creating a custom layout. In the presently preferred embodiment the homepage 15 enables the trip participants to optionally select and, using a voting tool, vote on the destination, hotel, and side excursion events that will be voted. FIG. 4 is an example of a trip homepage, and shows facilities for adding air, hotel and car, the invited participant list and status of invitees, and various features such as a message board, polls enabling votes to be cast, and other trip-information. Note that this screen displays information regarding the current trip (Vacation to Key West), as well as identifiers for other trips (e.g., RSS Business Trip and Brian's Graduation) thereby providing access to these other trips.

As part of the registration process the trip leader enters the names and email addresses of those persons that he or she wishes to invite to be part of the travel group. This list can be changed at a later time to add or delete participants. In response, the travel service 10 automatically transmits a standard message, or a trip leader-customizable message, such as an email, to all listed potential trip participants. The email invites the identified potential trip participants to join the trip, greets them by name, uses the trip leader's name in the salutation and provides a link to the trip leader's homepage 15. After clicking the link and arriving at the homepage 15 the invitee registers, and may use the features described under the trip organizing tools 15A below. These tools 15A include tools for at least one of: enabling the trip participant invite additional trip participants (possibly requiring permission from the trip leader and/or the other trip participants); using a message board for posting messages for other trip participants, including the trip leader; using the voting tool; and researching destinations, hotels and other trip-related subjects. All such information is stored in a database (DB) of the memory 14A for this particular trip, and is retrieved when appropriate.

Information regarding active trip groups is preferably private by default, although an option to list the trip as public may be selected by the group leader during registration. In this latter case the trip may be listed under a searchable database by drop-down box, map, tabs, tables or any number of other suitable techniques to access “Trip groups under way” or existing travel groups within the travel service 10 homepage that are currently active. Information regarding active trip groups may also be searchable by “leader name” (see FIG. 3) that anyone accessing the travel service homepage can look through. Information such as the purpose of the trip, destination, hotel (if decided upon) and the leader's name may be made publically available. In this case a member of the public may be enabled to access the homepage of the travel service 10, learn of the existence of one or more group trips, and join a particular group trip (or trips) to a destination or destinations of interest to the person. However, some group trips may be maintained private, by express invitation only, and are not listed under the general tab, drop-down box, map, tables, etc. As was noted, the trip leader, when first registering a group trip, can designate whether the group trip will be available to the public or available only to specific persons (private). If the latter is true, the ability of a trip participant to invite another participant may be restricted.

The trip leader's webpage 15 offers certain tools 15A to help organize the trip. These tools include one or more of the following, and need not be limited to only the following.

(A) A tool providing access information relevant to the trip including pricing, availability, hotel options, airline options, car rental options, extra excursions, restaurants, and any other relevant information.

(B) There may also be provided, in the preferred embodiment, a tool providing an ability to register and pay online through either a merchant bank or a payment service such as Paypal™. Once an individual pays for a trip, the payment event is indicated next to their name on the homepage 15 by a check mark or by a color change or by some other means. In this manner those having access to the homepage 15 are enabled to quickly determine how many invited trip participants have committed to making the trip by paying.

(C) There may also be provided, in the preferred embodiment, a tool enabling participants to vote on any of a number of matters, such as trip destination, trip dates and hotel. Each member may vote once, and the results are displayed. The voting tool can also be used for making group decisions on other matters, such as whether to allow a proposed participant to join the group. The trip leader may determine the duration of a particular ballot, the subject of the ballot, whether a simple majority is sufficient to win the vote, and other matters. The voting may be secret, or the voters names may be published, optionally along with their vote.

(D) There may also be provided, in the preferred embodiment, a tool enabling the participants to post messages to a group message board.

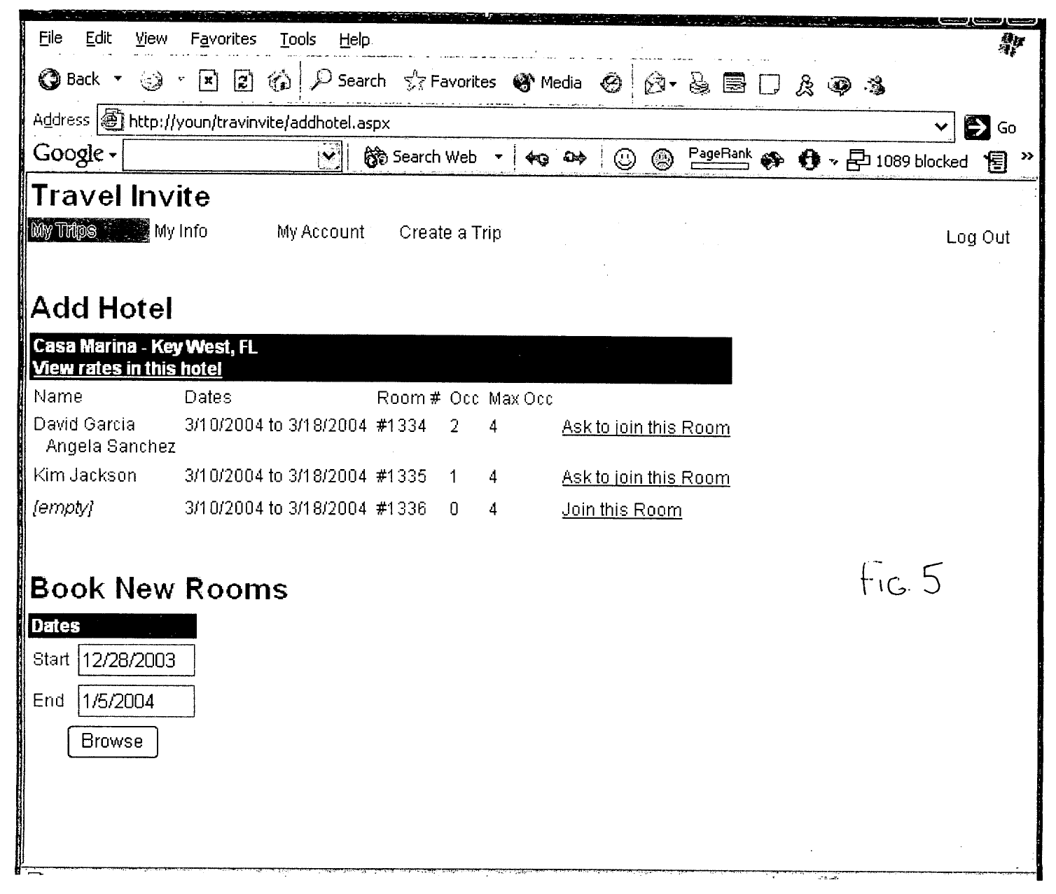

(E) There may also be provided, in the preferred embodiment, a tool for organizing hotel accommodations as to room sharing and the number of persons to a room. Once the participants have determined how many people to a room they want, blank lists are created with room names (room 1, room 2, . . . , roomₙ), and participants can then select a roommate or roommates by entering their name in one of the lists. The number of lists, and the number of entries per list, can be changed as the trip arrangements evolve over the days or weeks leading up to the trip. Also, trip members can invite one another to share a room, where the invited person would accept or reject the offer. Reference in this regard can be made to FIG. 5.

(F) There may also be provided, in the preferred embodiment, a matrix tool providing for tracking all invitees information, participation response, payment status, flight itinerary and number, seat assignment, hotel accommodation, room assignment, and other pertinent information. This feature enables a plurality of trip participants to coordinate the booking of flights, seating, and hotel rooms.

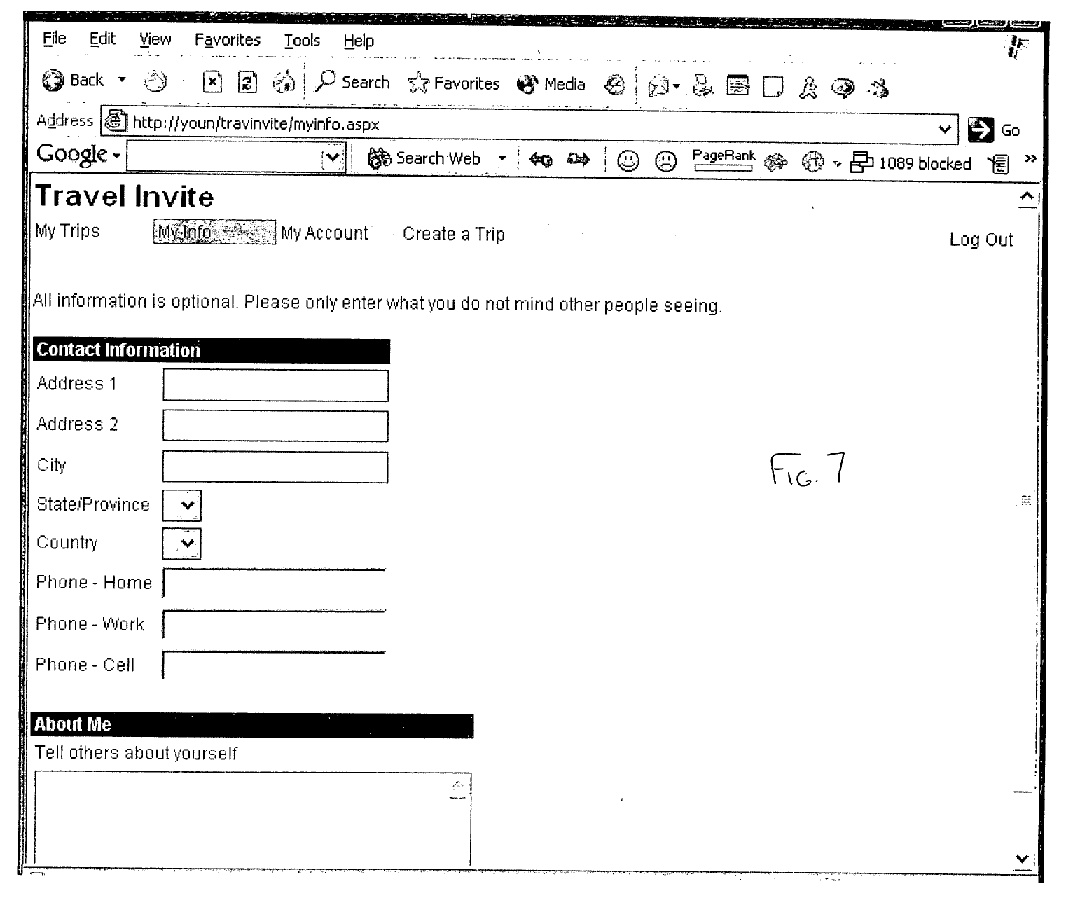

(G) There may also be provided, in the preferred embodiment, a profile tool for each participant that tracks the personal itinerary, keeps record of hotel confirmation numbers, a link to the flight e-ticket confirmation printout, and any other personal information pertinent to the trip. This profile is preferably accessible only by the individual participant upon logging in to the site with a distinctive login user identification and password. Optionally the participant may create a public profile that can be viewed by others, and that may contain information not pertinent to the trip such as: a photo, favorite color, favorite place, zodiac sign, most memorable trip, etc. Some of these profile items may be established as questions set by the trip leader upon initial registration, and that are expected to be answered by the participants as they register for the trip. General reference in this regard can be made to FIG. 7.

(H) There may also be provided, in the preferred embodiment, a tool for the trip leader to post documents or hyperlinks related to the trip (e.g., directions in PDF format)

While described thus far in the context of the trip participants interacting with the travel service 10, it should be appreciated that other interested parties, such as family members and friends, may access contact information for trip participants through the leader's homepage 15 (the tool 40 shown in FIG. 3 is particularly useful for this purpose). Also, at least group trip participants may upload via the Internet 16 text and/or images relevant to the trip to a Travel Log Album 20 maintained in the memory 14A by the travel service 10 for an ongoing trip, as well as for completed trips. The trip participants may be prompted for the name and email address of any family or friends they wish notified of the contact information and the existence of, and possibly a direct link to, the Travel Log Album 20. In response, the travel service 10 automatically sends an email to all identified friends and family that informs them of the trip, refers to them by name, uses the trip leader's or member's name in the greeting, and provides a link to the trip leader's webpage 15 and/or to the Travel Log Album 20.

Note in this regard that the public, such as family and friends, may be given the opportunity to download text and images from the Travel Log Album 20. This may be a value added service, as may be an ability to select and order certain images to be professionally printed and delivered, such as digital photographs, from the Travel Log Album 20.

For certain destinations and events, when the trip leader registers he or she is prompted to enter a “representative code” found on promotional material. Each user or attendee then may use that representative code to register for a contest (e.g., a free vacation, free hotel stay), and allows the travel service 10 to track the sales performance of its sales representatives. Participants may also enter promotional discount codes that would reduce their trip price or the trip price for all group members.

The foregoing method and system are applicable for any type of trip for two or more people. The method and system can be customized to work for an individual travel service provider. For example, a sport fishing company could hire the travel service 10 to sell their trips. In this case the travel service 10 may customize a portion of its site to include all the relevant information for the sport fishing company, such as including a field for fishing license/permit information, permit online reservations and allow online payment to be made. The fishing company may also interface with the travel service 10 to allow customers to manager their trip and make reservations directly from the web site of the fishing company. Thus, the travel service 10 may partner with other sites through the use of an API and web services.

The travel service 10 may allow users to plan their own custom tailored trips through a suite of pre-arranged travel partners. For example, five friends traveling together to a wedding may use the method and system to make all pertinent reservations. In this case a trip leader, which could be any one of the five friends, registers with the travel service 10 which automatically sends emails to the others. The others then access the leader's homepage 15 and select the travel dates, select airline tickets, select a hotel in the destination city, and select a roommate or roommates (if desired) through the trip-organizing tools 15A. Each potential group trip participant may then have the ability to invite others through the same system. The travel service 10 in this case preferably has pre-arranged agreements with one or more of hotels, restaurants, car rental firms, airlines, a provider of a global distribution system, and/or with a travel package wholesaler who arranges pre-packaged trips.

Certain trip types that benefit from this invention include, but are not limited to, cruises, safaris, music festivals, rafting trips, fishing trips, camping trips, sporting trips (e.g., World Series, Super Bowl), weddings, school and family reunions, as well as business trips including conferences, seminars, motivational and team-building outings, and conventions.

While described in the context of presently preferred embodiments, those having skill in the art should appreciate that a number of modifications may be made to the described embodiments, and that certain equivalent embodiments, features and items may be substituted, and that all such modifications and equivalents will fall within the scope of this invention.

What is claimed is:

1. A method to organize a trip, comprising:
at a travel service site, establishing a homepage for the trip;
sending an electronic notification to potential trip participants from the travel service site for informing them of the existence of the trip homepage; and
making at least travel arrangements related to the trip by using tools provided to the potential trip participants at the trip homepage.

2. A method as in claim 1, where one of said tools enables trip participants to vote on matters related to the trip.

3. A method as in claim 1, where emailing includes sending a link to the homepage.

4. A method as in claim 1, where the travel arrangements comprise arranging payment for the trip.

5. A method as in claim 1, where the travel arrangements comprise arranging accommodations during the trip.

6. A method as in claim 1, where the travel arrangements comprise determining which trip participants will share lodging accommodations during the trip.

7. A method to provide a group travel service over the Internet, comprising:
at a travel service site, in response to a group trip leader establishing a homepage for a group trip, the group trip leader identifying at least email addresses of potential group trip participants, automatically contacting the potential group trip participants from the travel service site for providing them with a link to the group trip homepage; and
making travel arrangements related to the group trip by using tools provided to the potential trip participants at the group trip homepage.

8. A method as in claim 7, where one of said tools enables trip participants to vote on matters related to the trip.

9. A method as in claim 7, where the travel arrangements comprise arranging payment for the trip.

10. A method as in claim 7, where the travel arrangements comprise arranging accommodations during the trip.

11. A method as in claim 7, where the travel arrangements comprise determining which trip participants will share lodging accommodations during the trip.

12. A method as in claim 7, further comprising enabling a member of the public to learn of the existence of the group trip, and join the group trip as a group trip participant.

13. A method as in claim 7, further comprising establishing a travel log album for the trip at the travel service site, and giving group trip participants access to the travel log album.

14. A method as in claim 7, further comprising establishing a travel log album for the trip at the travel service site, and giving both group trip participants and members of the public access to the travel log album.

15. A method as in claim 14, where at least group trip participants are enabled to upload photographs to the travel log album, and where group trip participants and members of the public are enabled to download photographs from the travel log album.

16. A system operable to provide a group travel service over the Internet, comprising a server executing software for implementing the group travel service, said server being bidirectionally coupled to the Internet and responsive to a group trip leader identifying contact information for potential group trip participants for automatically contacting the potential group trip participants for providing them with a link to a group trip homepage, said server being further responsive to potential group trip participants accessing the group trip homepage for making travel arrangements related to the group trip by using tools provided to the potential trip participants at the group trip homepage, said travel arrangements comprising at least one of arranging payment for the trip and arranging accommodations during the trip.

17. A system as in claim 16, where said travel arrangements further comprise determining which trip participants will share lodging accommodations during the trip.

18. A system as in claim 16, where one of said tools enables trip participants to vote on matters related to the trip.

19. A system as in claim 16, said server further establishing a travel service homepage for enabling a member of the public to learn of the existence of the group trip, and to join the group trip as a group trip participant using at least the group trip homepage.

20. A system as in claim 16, further comprising establishing a travel log album for the trip at the travel service site, and providing both group trip participants and members of the public access to the travel log album, where at least group trip participants are enabled to upload photographs to the travel log album, and where group trip participants and members of the public are enabled to download photographs from the travel log album.
